(19) United States
(12) Patent Application Publication
(10) Pub. No.: US 2005/0179388 A1
(43) Pub. Date: Aug. 18, 2005

(54) Discharge lamp and method of forming same

(76) Inventor: Jack M. Strok, Garrettsville, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/781,011

(22) Filed: Feb. 17, 2004

(51) Int. Cl. H01J 17/16; H01J 17/18; H01J 61/36; H01J 61/30

(52) U.S. Cl. 313/634; 313/318.07; 445/26; 445/22; 313/623

(57) ABSTRACT

An arc lamp includes a light transmissive body having a first end and a second end. A first lead assembly is disposed along the first end and a second lead assembly is disposed along the second end. A first surface of rotation is formed on the first end and a second surface of rotation is formed on the second end that is different from the first surface of rotation. At least one of the first surface of rotation and the second surface of rotation is formed by pinching the body at a respective one of the first and second ends. A method of forming is also included.

### BACKGROUND OF THE INVENTION

The present invention broadly relates to the art of lighting systems and, more particularly, to a discharge lamp having an arc tube optimized for use in a vertical orientation and a method of forming the optimized arc tube.

The present invention is generally applicable for use in the manufacture of discharge lamps having metal halide arc tubes, such as those having a quartz metal halide arc tube, for example, and will be discussed with particular reference thereto. However, it is to be specifically understood that the present invention is equally applicable for use in association with other discharge lamps, and that such lamps can be used in any suitable lighting application, such as indoor and/or outdoor lighting applications, for example. Additionally, discharge lamps according to the present invention can be adapted for use in a wide variety of wattages, such as from about 250 watts to about 600 watts.

It is generally well known by those of skill in the art to use a method of pinch or press forming to shape the ends of an arc tube. Typically, each end includes a seal portion and a surface of rotation. To promote the economical manufacture thereof, arc tubes manufactured by the pinch or press forming method normally have opposing ends that are commonly configured. In some arc tubes both ends are formed in the shape of a cone. In other arc tubes, both ends are formed in the shape of an ellipse. In either case, such a construction having two commonly configured ends is a disadvantage where the arc tube is used in a vertical orientation. This is due, at least in part, to the thermal activity of and within the arc tube, as is well understood by those of skill in the art.

In an arc tube, the upper end typically operates at a considerably higher temperature than the lower end. This can be particularly problematic as the temperature at the upper end during operation can reach levels that undesirably limit life and/or performance of the arc tube. Commonly, the operating temperature at the lower end of such an arc tube, however, is at a suitable level for the desired performance and operation of the arc tube.

In discharge lamps, such as those utilizing quartz metal halide arc tubes, it is well understood that efficiency generally increases as the operating temperature of the arc tube increases. In such lamps, however, there is an upper temperature limit that may be reached beyond which the dosing ingredients of the arc tube tend to adversely react with the quartz. This is a disadvantage that is particularly apparent in arc tubes having cone-shaped ends, due to a hot spot that is formed at the upper end thereof. To avoid the life and performance limiting effects of such hot spots, the overall operating temperature of the arc tube is often reduced. However, this undesirably reduces the efficiency of the arc tube and is, therefore, a less than optimal solution. Accordingly, a tradeoff exists between competing design considerations.

In arc tubes having two ellipsoidal end configurations, the temperature at the upper end is again significantly higher than that at the lower end. The use of an ellipsoidal shape on the upper end of the arc tube tends to minimize or eliminate the hot spot found in arc tubes having a cone-shaped end and therefore operates at a significantly lower temperature than arc tubes having a cone-shaped upper end. In arc tubes having ellipsoidal end configurations, the upper end typically has an operating temperature within a suitable range for producing the desired output and performance life of the arc tube. However, as the lower end is of a significantly reduced temperature from that of the upper end, the operating temperature at the lower end is commonly too low to produce the desired output and performance of the lamp. As such, it is common to apply a reflective coating along the bottom end of the arc tube to increase the operating temperature at the lower end thereof. However, the application of the coating undesirably increases the cost of production of the arc tube. Additionally, the application of too much coating can undesirably affect the performance of the arc tube, such as by blocking light.

Other arc tubes are known that have been optimized for use in a vertical orientation. However, such arc tubes are typically manufactured using a blow-molded or blow-forming method or process. In such method, a small diameter tube is heated, softened and then blown out from the inside into a mold cavity that has the desired body shape and/or end configuration. Such lamps are commonly tear-shaped and typically have at least one end that is bulged to a greater extent than the other, which is typically pointed. One disadvantage of such arc tubes, however, is that the same have historically been expensive to manufacture due to the inherent inefficiencies of the known manufacturing processes. Low wattage, blow molded quartz metal halide arc tubes are known to have been designed without end coats. However, these arc tubes typically have symmetrical ends.

Consequently, a need exists for a new lamp—particularly a lamp operated in a vertical orientation—that overcomes the above-noted deficiencies in a manner that is easily and economically manufactured.

### BRIEF DESCRIPTION OF THE INVENTION

A method of forming an arc tube optimized for use in a vertical orientation is provided and includes a step of providing a light-transmissive body having an open first end and an open second end. Other steps include inserting a first lead assembly into the body at the first end and pinch forming a first surface of rotation on the first end of the body. Further steps include inserting a second lead assembly into the body at the second end and pinch forming a second surface of rotation that is different from the first surface of rotation on the second end of the body.

Additionally, an arc lamp is provided and includes a light-transmissive body having a first end and a second end. A first lead assembly is disposed along the first end and a second lead assembly is disposed along the second end. A first surface of rotation is formed on the first end, and a second surface of rotation is formed on the second end that is different from the first surface of rotation. At least one of the first surface of rotation and the second surface of rotation are formed by pinching the body at a respective one of the first and second ends.

Furthermore, an arc lamp optimized for use in a vertical orientation is provided and includes a light-transmissive body having an upper end, a lower end and an axis extending centrally along the body between the upper and lower ends. An upper lead assembly is disposed along the upper end and has an upper electrode tip. A lower lead assembly is disposed along the lower end and has a lower electrode tip. A first surface of rotation is pinch formed on the upper end and a second surface of rotation is pinch formed on the lower end that is different from the first surface of rotation. The arc lamp has a thermal profile measured along the axis from about the upper electrode tip to about the lower electrode tip. The thermal profile has a maximum thermal value, a minimum thermal value and an average thermal value for the thermal profile. The minimum and maximum thermal values are within about 35° C.-50° C. of the average thermal value.

### BRIEF DESCRIPTION OF THE DRAWINGS

FIG. 1 is a side elevation view, partially in cross section, of one embodiment of a discharge lamp having an arc tube in accordance with the present invention.

FIG. 2 is an enlarged side view of the arc tube of FIG. 1.

FIG. 3 is a flow chart showing steps in one method in accordance with the present invention.

FIG. 4 is a graph illustrating thermal profiles along arc tubes of various configurations.

### DETAILED DESCRIPTION OF THE INVENTION

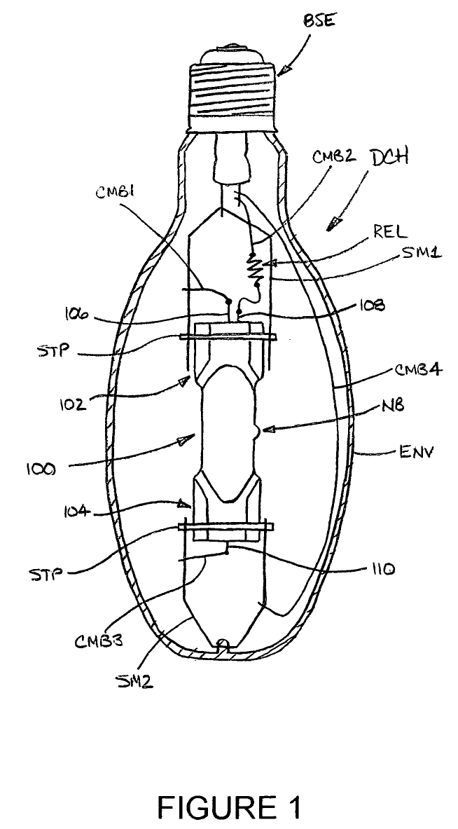

Vertically oriented discharge lamps typically have a base-up or a base-down configuration. In FIG. 1, a discharge lamp DCH is shown supporting an arc tube 100 in a vertical, base-up orientation. Discharge lamp DCH includes a base BSE and an outer envelope ENV. Base BSE includes suitable electrical contacts for making electrical connection to the arc tube 100 and is well known by those of skill in the art. Outer envelope ENV is preferably formed from a vitreous, light-transmissive material, such as glass, and is secured to base BSE in a conventional manner. Support members SM1 and SM2 are secured within envelope ENV in a suitable manner, and arc tube 100 is secured therebetween by straps STP. The support members and straps are formed from a suitable material, such as nickel coated steel. Arc tube 100 has a first or upper end 102 and a second or lower end 104. Extending from upper end 102 are inleads 106 and 108, and extending from lower end 104 is inlead 110. Discharge lamp DCH includes conductive members CMB1, CMB2, CMB3 and CMB4 that are in electrical communication with base BSE in a manner well known by those of skill in the art. Conductive members CMB1, CMB2 and CMB3 are in electrical communication between base BSE and inleads 106, 108 and 110, either directly or through the support members. Conductive member CMB2 can be formed as or include a resistive element REL as is well known by those of skill in the art. Additionally, those skilled in the art will also recognize that conductive member CMB2 and inlead 108 are optional, depending upon ballast type.

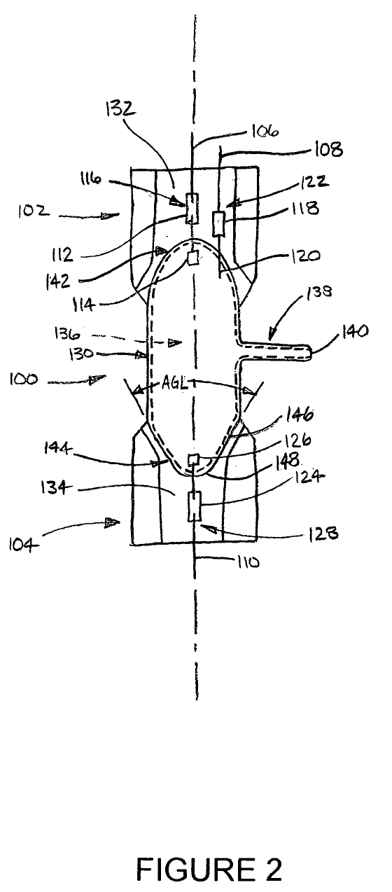

As can be better seen in FIG. 2, along upper end 102, a conductor foil 112 is connected between inlead 106 and an electrode 114 forming a lead assembly 116. Optionally, a conductive foil 118 is connected between inlead 108 and an electrode 120 forming a lead assembly 122. At lower end 104, a conductive foil 124 is connected between inlead 110 and an electrode 126 forming a lead assembly 128. In one preferred construction, the electrodes are formed from tungsten and the inleads and foils are formed from molybdenum.

Arc tube 100 is formed from an inner envelope or body 130 made of a high temperature, light-transmissive, vitreous material, such as quartz, for example. Sealed areas 132 and 134 are respectively formed at ends 102 and 104 of arc tube 100. The sealed areas preferably form a fluid tight seal along each end of the body. In one preferred embodiment, the sealed areas are aligned with the foils of the respective lead assemblies at each end, as is well known by those skilled in the art. Sealed areas 132 and 134 substantially fluidically isolate an arc chamber 136 formed therebetween along body 130. As can be seen from FIG. 2, the tips of electrodes 114, 120 and 126 are disposed within arc chamber 136.

Additionally, arc tube 100 can include an evacuation tube 138 projecting from body 130. The evacuation tube is preferably hollow with an open end 140, such that arc chamber 136 is in fluid communication with the ambient atmosphere through the evacuation tube. As an example of a suitable construction, evacuation tube 138 can have an inside diameter of about 3 mm and an outside diameter of about 5 mm. It will be appreciated that the process of forming the evacuation tube, sometimes called tubulation, is well known by those of skill in the art. The evacuation tube can be used to evacuate and dose or otherwise fill the arc chamber. Thereafter, evacuation tube 138 is tipped off or otherwise trimmed and sealed forming nub NB in FIG. 1.

An upper end wall or surface of revolution 142 of arc chamber 136 is formed on upper end 102 adjacent sealed area 132. A lower end wall or surface of revolution 144 of arc chamber 136 is formed on lower end 104 adjacent sealed area 134. As can be clearly seen from FIGS. 1 and 2, surface of revolution 142 has a significantly different conformation or shape than surface of revolution144. Surface of revolution 142 is preferably ellipsoidal, and can be limited at one extent by approximating a hemispherical end cap. Surface of revolution 144 is preferably cone shaped having a frustoconical portion 146 and a somewhat spherically-shaped portion 148. Frustoconical portion 146 has an included angle AGL of any suitable value, such as from about 20 degrees to about 100 degrees, and preferably from about 30 degrees to about 90 degrees. Angle AGL is shown in FIG. 2 at about 60 degrees. Even with a cone-shaped surface of revolution 144 formed on arc tube 100, it may in some cases remain desirable to include a suitable reflective end coating along lower end 104. Such coating material can be of a wide array of materials and is preferably a white oxide material that is stable and non-reactive with the material forming the body, such as quartz, at the operating temperatures of the arc tube. Suitable alternative oxide materials include aluminum oxide and zirconium dioxide, for example.

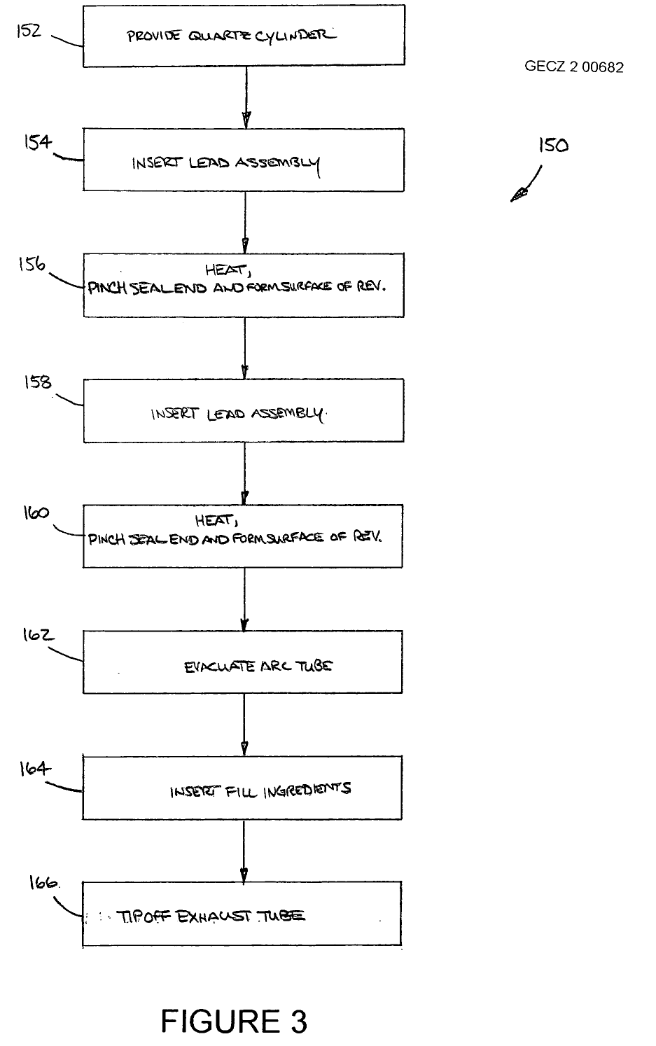

FIG. 3 illustrates a method 150 of forming an arc tube, such as arc tube 100 described above. Initially, a body, such as body 130, is provided as a thin-walled, hollow tube or cylinder, as indicated at step 152. Such an initial quartz cylinder can be cut from a length of low-cost quartz tubing, for example. In another step 154, one or more lead assemblies is inserted into one end of the cylinder, such as inserting lead assemblies 116 and 122 at end 102, for example. In another step 156, a sealed area, such as sealed area 132, is formed on the end of the body by heating the end of the cylinder and then pinching or pressing a portion of the heated end of the cylinder together at least partially encapsulating the one or more lead assemblies disposed therein. Additionally, in step 156 a first surface of revolution, such as surface of revolution 142, for example, is formed on the end of the body. It will be appreciated that the end of the body is heated to a sufficiently high temperature to transform the material into a plastic or other formable state, and that such heating operations are well known and commonly used by those of skill in the art.

In still another step 158, one or more lead assemblies is inserted into the opposing end of the cylinder, such as inserting lead assembly 128 at end 104, for example. In another step 160, a sealed area, such as area 134, is formed by heating the end of the cylinder and then pinching or pressing the cylinder end together at the second and/or opposing end of the body, such as end 104. This step substantially completes the formation of an arc chamber, such as arc chamber 136. Additionally, in step 160 a second, different surface of revolution, for example, surface of revolution 144, is formed on the end of the body. Thus, a substantially fluid-tight arc chamber 136 is formed between ends 102 and 104 having different surfaces of revolution on each of the opposing ends. Preferably, the two different surfaces of revolution that are formed on the arc tube are optimized for use in a vertical orientation.

In yet another step 162, the cavity (e.g., arc chamber 136) is substantially evacuated and thereafter filled with suitable dosing ingredients, as indicated by step 164. Such dosing ingredients typically include an inert gas, such as argon, for example, metal halides and/or mercury. However, it will be appreciated that any suitable combination of dosing ingredients can be used without departing from the scope and intent of the present invention. Steps 162 and 164 can be performed in any suitable manner, such as through evacuation tube 138, for example. Evacuation tube 138 can be formed in a prior step, as is well known by those skilled in the art. In step 166, the evacuation tube is tipped off to seal the passage therethrough and remove a considerable portion of the tube, as is well known by those skilled in the art.

One skilled in the art will appreciate that although the flow chart of FIG. 3 is representative of a preferred method of forming the art tube, the particular order of steps, additional process steps, or combination of selected steps may be varied without departing from the scope and intent of the present invention. For example, providing a desired end coat can be introduced after insertion of a lead assembly to improve efficacy of the lamp.

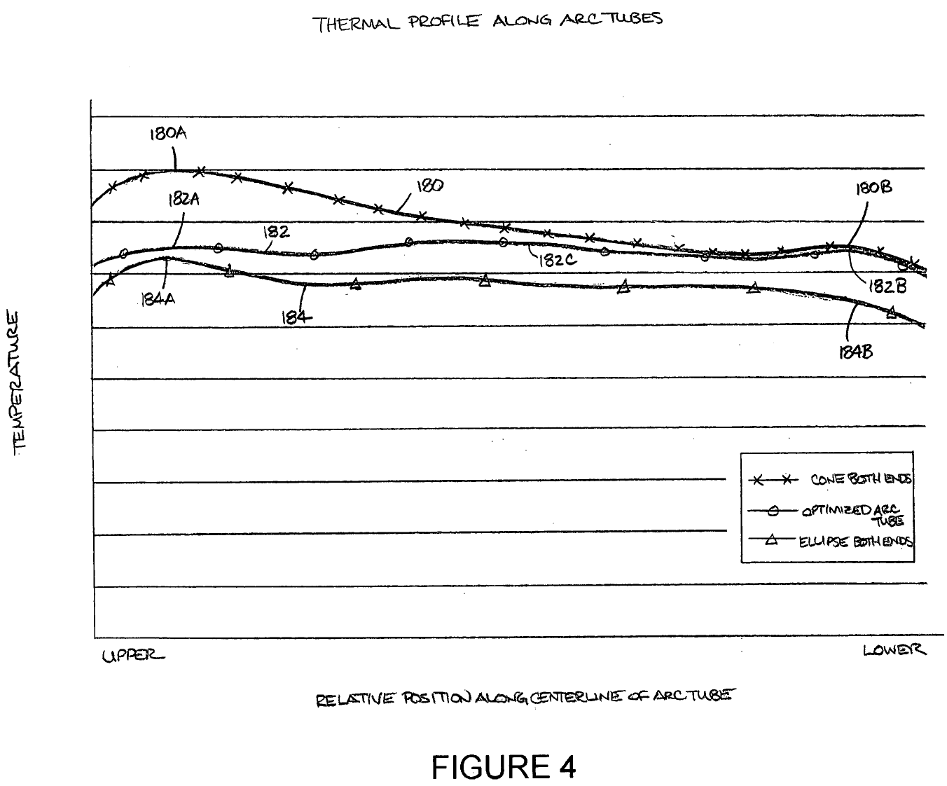

FIG. 4 illustrates a graph of arc tubes having different end configurations. Plot 180 represents a thermal profile taken along the axis of an arc tube having a cone formed on both ends thereof. Plot 182 represents a thermal profile taken along the axis of one embodiment of an arc tube in accordance with the present invention having an ellipsoidal upper surface of revolution and a cone-shaped lower surface of revolution. Plot 184 represents a thermal profile taken along the axis of an arc tube having ellipsoidal ends.

The data plots in FIG. 4 correspond to a sample of arc tubes operating at about 360 watts. It is believed that known arc lamps configured for greater wattages, such as about 400 W and about 600 W, for example, will operate with increasingly disadvantageous thermal profiles. That is, it is expected that higher wattage arc lamps will have high temperature areas or hotspots that operate at even higher temperatures than those shown in FIG. 4. Said differently, the plots in FIG. 4 represent thermal profiles that are relatively good compared to those that are anticipated for higher wattage arc lamps. Importantly, arc lamps of from about 250 W to about 600 W are all typically made from the same quartz material. As such, the higher the temperature at the hotspots, the more the life of the arc lamp is reduced. It is to be distinctly understood that the wattage value stated herein are nominal wattage values and that actual wattages may vary from arc lamp to arc lamp. For example, a 360 W arc lamp may operate at from about 350 W to about 370 W, a 400 W arc lamp may operate at from about 390 W to about 410 W, and/or a 600 W arc lamp may vary from 580 W to 620 W.

Returning now to FIG. 4, plot 180 indicates hot spots 180A at the upper end of the arc tube and 180B toward the lower end thereof. The upper hot spot is undesirable and may be life limiting or performance limiting, as the high temperature can drive undesirable reactions in the associated arc tube, such as an adverse reaction causing sodium loss in quartz arc tubes. In this example, plot 180 has an upper hot spot temperature 180A near the upper electrode tip of about 900° C., and a lower hot spot temperature 180B near the lower electrode tip of about 750° C.

Plot 184 has an upper hot spot temperature 184A of about 730° C. and a lower hot spot temperature 184B of about 650° C. Unfortunately, such a temperature at the lower end of the arc tube is often too low to support the desired vapor pressures of the halide ingredients within the arc tube to get the maximum efficiency thereof. In some cases, a reflective coating is deposited along the lower end of such arc tubes to boost the operating temperature thereof. However, the application of such coatings increases the cost of production of the arc tube and, in some cases, can undesirably affect the light output.

As can be seen from plot 182, an arc tube having an ellipsoidal upper surface of rotation and a cone-shaped lower surface of rotation eliminates undesirable hot spots, such as hot spot 180A. Moreover, this arc tube maintains an increased temperature at the lower end, thereby eliminating or reducing the need for the application of reflective coatings. As indicated by plot 182, the upper end of the arc tube operates at a maximum temperature 182A of about 750° C. and the lower end of the arc tube also operates at a temperature 182B of about 750°. The maximum operating temperature of the middle portion of the arc tube, as indicated along plot 182, is shown as a substantially constant or linear portion 182C at about 750° C. The thermal profile of the arc lamp has an average thermal value from which the temperature near the upper end and the temperature near the lower end do not deviate by more than approximately 35° C. With an arc tube operating at from about 400 W to about 600 W, it is believed the thermal profile of the arc lamp will have an average thermal value from which the temperature near the upper end and the temperature near the lower end do not deviate by more than approximately 50° C.

In summary, the present invention obtains the advantages of a blow-molded shaped quartz body, but with a much less costly process. Cylindrical quartz stock is pinch-sealed at both ends. For arc tubes designed for vertical burning orientation, the upper pinched bowl shape is preferably elliptical or hemispherical, and the lower pinched bowl shape is conical. The advantage of the conical lower bowl is that it conserves heat. This means that it requires the application of less end coating at the lower end than an elliptical or hemispherical lower bowl requires. Less end coating at the lower end provides higher efficacy.

The advantage of an elliptical or hemispherical upper bowl is that it helps dissipate heat. The upper bowl of a vertical burning metal halide arc tube made from cylindrical quartz, with pinched end of the same shape, operates at a higher temperature than the lower bowl, due to convection. Since the highest quartz temperature limits the arc tube life, top-bottom asymmetry can provide longer life. Moreover, it is relatively easy and inexpensive to make an asymmetric arc tube from a cylindrical piece of quartz with well-known pinch technology (using different molds at each end), than it is to make an asymmetric arc tube by blow-molding.

While the invention has been described with reference to the foregoing embodiments and considerable emphasis has been placed herein on the structures and structural interrelationships between the component parts of the embodiments disclosed, it will be appreciated that other embodiments of the invention can be made and that many changes can be made in the embodiments illustrated and described without departing from the principles of the invention. Obviously, modifications and alterations will occur to others upon reading and understanding the preceding detailed description. Accordingly, it is to be distinctly understood that the foregoing descriptive matter is to be interpreted merely as illustrative of the present invention and not as a limitation. As such, it is intended that the invention be construed as including all such modifications and alterations insofar as they come within the scope of the appended claims and the equivalents thereof.

1. A method of forming an arc tube optimized for use in a vertical orientation, said method comprising steps of:
a) providing a light transmissive body having an open first end and an open second end;
b) inserting a first lead assembly into said body at said first end;
c) pinch forming a first surface of rotation on said first end of said body;
d) inserting a second lead assembly into said body at said second end; and,
e) pinch forming a second surface of rotation different from said first surface of rotation on said second end of said body.

2. A method according to claim 1 further comprising steps of sealing said first lead assembly on said first end of said body and sealing said second lead assembly on said second end of said body.

3. A method according to claim 2, wherein one of said step of sealing said first lead assembly is performed simultaneously with step c) and said step of sealing said second lead assembly is performed simultaneously with step e).

4. A method according to claim 2, wherein each of said seals are formed outwardly of respective ones of said first and second surfaces of rotation.

5. A method according to claim 1, wherein said first surface of rotation in step c) is one of an ellipsoid and a cone.

6. A method according to claim 5 wherein said second surface of rotation in step g) is the other of said ellipsoid and said cone.

7. A method according to claim 6 further comprising a step of applying a reflective end coating along said end of said body having said cone.

8. A method according to claim 1 further comprising steps of substantially evacuating said quartz cylinder and inserting a quantity of dosing ingredients into said substantially evacuated cylinder after step e).

9. A method according to claim 1 further comprising a step of inserting a third lead assembly prior to step e).

10. A method according to claim 9, wherein said step of inserting a third lead assembly is performed simultaneously with one of steps b) and d).

11. An arc lamp formed according to a method of claim 1.

12. An arc lamp comprising:
a light transmissive body having a first end and a second end;
a first lead assembly disposed along said first end and a second lead assembly disposed along said second end; and,
a first surface of rotation formed on said first end and a second surface of rotation formed on said second end that is different from said first surface of rotation;
at least one of said first surface of rotation and said second surface of rotation being formed by pinching said body at a respective one of said first and second ends.

13. An arc lamp according to claim 12, wherein said first surface of rotation is one of an ellipsoid and a cone.

14. An arc lamp according to claim 13, wherein said second surface of rotation is the other of said ellipsoid and said cone.

15. An arc lamp according to claim 14, wherein said cone has an included angle of from about 30° to about 90°.

16. An arc lamp according to claim 14, wherein said ellipsoid is approximately hemispherical.

17. An arc lamp optimized for use in a vertical orientation comprising:
a light transmissive body having an upper use end, a lower use end and an axis extending centrally along said body between said upper and lower use ends;
an upper lead assembly disposed along said upper use end and having an upper electrode tip;
a lower lead assembly disposed along said lower use end and having a lower electrode tip; and,
a first surface of rotation pinch formed on said upper use end and a second surface of rotation pinch formed on said lower use end that is different from said first surface of rotation;
said arc lamp having a thermal profile measured along said axis from about said upper electrode tip to about said lower electrode tip, and said thermal profile having a maximum thermal value, a minimum thermal value and an average thermal value for said thermal profile;
said minimum and maximum thermal values being within about 35° C.-50° C. of said average thermal value.

18. An arc lamp according to claim 17, wherein said arc lamp is configured to operate at a wattage of from about 350 W to about 370 W.

19. An arc lamp according to claim 18, wherein at said wattage said minimum and maximum thermal values are within about 35° C. of said average thermal value.

20. An arc lamp according to claim 17, wherein said arc lamp is configured to operate at a wattage of from about 390 W to about 610 W.

21. An arc lamp according to claim 20, wherein at said wattage said minimum and maximum thermal values are within about 50° C. of said average thermal value.
